(19) United States
(12) Patent Application Publication
(10) Pub. No.: US 2011/0309935 A1
(43) Pub. Date: Dec. 22, 2011

(54) WORKPLACE MANAGEMENT SYSTEM

(75) Inventors: Peter Norman Emmett, Park Orchards (AU); Salvatore Paolilli, East Doncaster (AU)

(73) Assignee: Southern Plant Hire PTY LTD, Keysborough, Victoria (AU)

(21) Appl. No.: 13/203,638

(22) PCT Filed: Feb. 26, 2010
(86) PCT No.: PCT/AU2010/000228

§ 371 Date: Aug. 26, 2011

(30) Foreign Application Priority Data
Feb. 26, 2009 (AU) 2009900844

(51) Int. Cl. G08B 13/14

(52) U.S. Cl. 340/572.1

(57) ABSTRACT

The present invention relates to the field of managing tasks undertaken by employees or contractors in the work-place. In one form, the invention has application to a construction site in which vehicles moving onto and/or exiting the site need to be tracked. In one particular aspect the present invention is suitable for use when trucks and loader loads need to be accounted for and tracked to ascertain a basis for remuneration.

### FIELD OF INVENTION

The present invention relates to the field of managing tasks undertaken by employees or contractors in the workplace.

In one form, the invention has application to a construction site in which vehicles moving onto and/or exiting the site need to be tracked.

In one particular aspect the present invention is suitable for use when trucks and loader loads need to be accounted for and tracked to ascertain a basis for remuneration.

It will be convenient to hereinafter describe the invention in relation to a construction site, however it should be appreciated that the present invention is not limited to that use only.

### BACKGROUND ART

Throughout this specification the use of the word “inventor” in singular form may be taken as reference to one (singular) inventor or more than one (plural) inventor of the present invention.

Earthworks are a major part on any construction project. Material is usually imported, exported or relocated elsewhere on site. The counting of loads in all cases is an important activity. Whether the equipment is being operated by the principle or is being sub-contracted, accurate load information is vital in controlling and managing a profitable work site.

The responsibility of tracking loads would normally fall to either a dedicated counter or the loader operator. In most cases the dump truck drivers are paid by load or by volume. Any manual counting system is prone to error, particularly in multiple loader environments. It is not uncommon for disputes to arise over discrepancies in loads. Furthermore, when different businesses are involved in providing equipment and services onsite, they are often reluctant to share information, which makes the task of reliably accounting for onsite activity difficult. This is particularly so when a large number of owner-operators are providing equipment and working onsite.

U.S. Pat. No. 7,246,009 discloses an asset allocation and management for concrete trucks and multiple batch plants. The system disclosed lacks portability and is primarily directed to the location or status of various trucks at any one time.

US2008011839 discloses a system which accounts for truck loads being moved to or from a site. However, the system disclosed requires a manual reading by a site manager. This means that a person is moving in and around trucks on site and presents a number of safety issues for that person. The data collected is also logged at the instigation of a person. Thus there may be some delay or omission of data.

The discussion throughout this specification comes about due to the realisation of the inventor and/or the identification of certain related art problems by the inventor and, moreover, any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

### SUMMARY OF INVENTION

An object of the present invention is to provide an improved system and method for tracking objects within the workplace.

It is a further object of the embodiments described herein to overcome or alleviate at least one of the above noted drawbacks of related art systems or to at least provide a useful alternative to related art systems.

In a first aspect of embodiments described herein there is provided a method of and/or system for tracking an object(s) in the workplace, comprising associating either a tag or reader with an object to be tracked, providing a corresponding reader or tag in the workplace, and tracking the object via at least one proximity event of the tag and reader.

In another aspect of embodiments described herein there is provided a method of and/or system for determining whether a object is functioning within a workplace, comprising associating a tag or reader with the object, providing a corresponding reader or tag in the workplace, monitoring the signal strength of the tag or reader, and determining from the monitored signal whether a first signal strength and a second, lower, signal strength is monitored.

Other aspects and preferred forms are disclosed in the specification and/or defined in the appended claims, forming a part of the description of the invention.

In essence, embodiments of the present invention stem from the realization that the proximity of an RFD tag and a reader to each other (a proximity event) can be used to determine if an item to be tracked is within a particular area. The proximity range is set or determined by the reading range of the tag and reader. For example, on a construction site, a truck may have a RFID tag and a loader may have a RFID reader, or visa-versa. When the truck moves proximate the loader, which will occur in order for the loader to fill the truck with dirt, for example, the tag and reader will couple and/or communicate with each other, and the reader and/or tag can record whatever details and/or information are required or set within the system. Because the tag has been within ‘reading range’ of the reader, preferably for a predetermined period of time, it can be assumed that the truck has been close enough to the loader to work or interact with the loader. Optionally, an image of the truck or its registration may also be recorded and associated with the tag reading event.

Advantages provided by the present invention comprise the following:
The system is transferable, for example transferable between sites, trucks and loaders.
RFID is useful in harsh environments. Line of sight is not necessary.
A load or volume measurement may also be associated with a tag reading event,
The RFID signal strength may be used to determine proximity.
The data accumulated by a reader and/or tag can be uploaded or synchronised automatically and/or periodically.
Because the data exists on a number of tags or readers onsite, the data is distributed, and thus, in the event of a failure of synchronisation, the data is retained by the tags and readers providing information redundancy,
The information collected may be used to:
   Create accurate rates for truck drivers
   Create accurate records for the principle
   Avoid dispute over loads
   Accurately forecast equipment requirements
   Forecast material movement rates
   Establish key performance indicators and comparisons between loaders and loader operators.
   Establish accurate historical records that can be used to quote further work.
   Identify training needs
   Stream line billing processes
   Identify bottlenecks/waiting times
   Equipment optimisation
   Record Loader operation hours
   Record Truck start and finish times
   Record photographic evidence of loads
   Deliver a competitive advantage.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 illustrates an embodiment of the present invention.

### DETAILED DESCRIPTION

Although the present invention has a number of applications, an example is given in which the present invention is applied to a construction site.

As noted above, earthworks are a major part on any construction project. Material is usually imported, exported or relocated elsewhere on site. The counting of loads in all cases is an important activity. In most cases the truck drivers are paid by load or by volume. Whether the equipment is being operated by the principle or is being subcontracted, accurate load information is considered vital in controlling and managing a profitable work site.

The present invention enables a proximity event (such as the loading of a truck) to be counted and (optionally) additional information may be recorded to ensure up to the minute data is available, on site or from anywhere via the web.
Recorded information;
Loads per truck per loader
Duration on site (by the use of additional transponders)
Truck waiting times (by the use of additional transponders)
Duration under loader
Photographic evidence of loads
Loading, unloading cycle times.
Site Details, notes etc

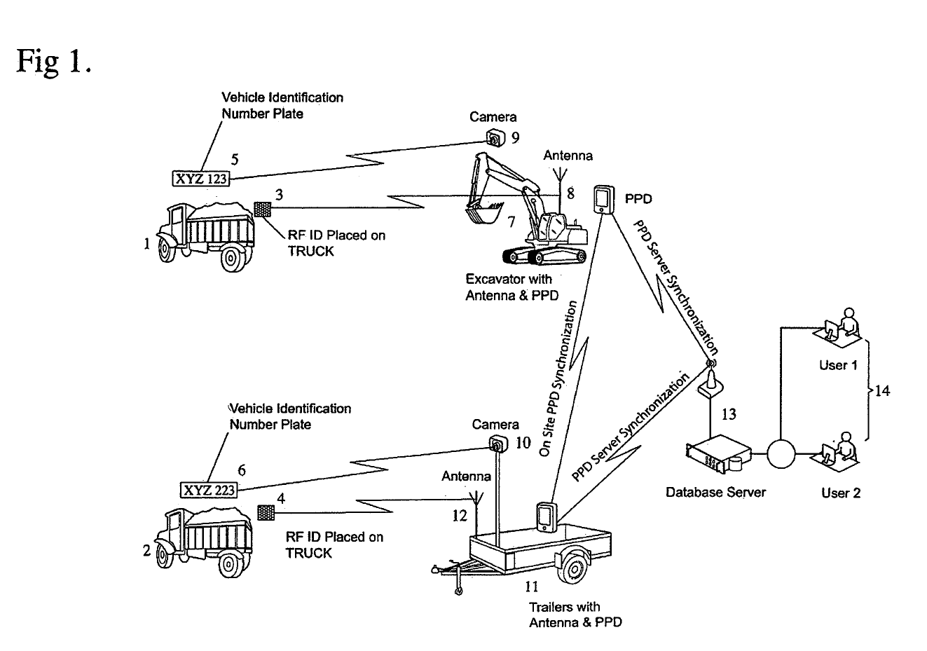

Referring to FIG. 1, trucks 1, 2 carry RFID tags 3,4 and optionally a registration number 5,6, to identify the truck to the system. The loader(s) 7 or portable stations 11 carry a tag interrogator or reader 8, 12. The RFID tags 3, 4 are provided so that they can be read by the RFID reader 8, 12 when the tags come into the interrogation range or proximity of the reader.

Optionally a camera 9, 10 may be provided to capture an image of a registration number 5, 6 attached to one or more trucks in a position that where an image of the number can be taken by the camera. This image can then be associated with each reading of the tag.

When a particular truck is to be loaded, the truck can move into a load position proximate the loader. The proximity of the truck's RFID tag and the RFID reader facilitates the reading of the adjacent truck's tag. If there are more than one tag proximate the loader, the particular tag associated with the truck being loaded may be selected automatically or by the loader driver. The loads counted would be tracked by a portable control system 11 which may be mounted in various locations within or around the construction site.

The present invention uses a number of technologies to provide relatively robust tracking of data including; RFID, local portable processor based devices, the mobile telephone network and a central data base system. In the example of an application to a construction site, the identification of each truck would require each truck carrying an RFID tag and in certain variants of the present invention a sign with its registration number.

A portable control system may be mounted in different locations including; on loaders 7 and in trailer based systems 11. Each portable control system 7,11 includes at least one or any combination of:
a portable processing device (PPD),
an RFID reader,
optionally a digital camera,
a mobile phone network modem and
a printer.

The PPD will have some onboard memory and a relatively accurate clock. The portable control system may communicate with a central server 13 that may be housed offsite at a central administration point. There may be a number of job sites running in conjunction with the present invention and they may all communicate back to a server and/or the same central server. Client(s) 14 via computers may communicate with the central server to access the data logged.

A first embodiment of the portable control system is a loader based control system. The loader based control system may be used in conjunction with the trailer based system or stand alone RFID gates. The loader based system may have the feature of easy transferability to different loaders on different days or jobs. The control system may be in a modular format, in which case the control system is made of separate modules that can be either physically located together or distributed, and may be made up of different number of modules depending on the system features required.

Other components may be added to the system, for example
Weighbridge
GPS
Additional RFID gates
Volume measurement.
Mechanisms facilitating ease of transfer

The control system may include a RFID reader, aerial and camera module that may be mounted internally or externally of the loader and preferably separately mounted, the PPD, modem and printer in side the loader.

A second variant of the portable control system is trailer based. The device is towed behind a vehicle to the job site. The device may be used in conjunction with the loader based system or stand alone. The device may include a trailer and an enclosure (on the trailer) for the control system. The control system may include a battery power pack for powering the device, a PPD, a relatively accurate clock, a mobile phone network modem and printer, an extending and retracting mast with a wireless identification system (RFID) and (optionally) a camera mounted on it. The trailer may be towed to a job site and strategically positioned so that all (or most) trucks on the site would be required to drive past it to be loaded and again to leave the site. The mast is extended to a height that makes it possible for the wireless identification reader (RFID) to identify the truck from its wireless identification (RFID) tag and for the camera to identify the truck and take an image of the body of the truck.

The PPD's preferably will store two main files; an association matrix file (AMF) and a truck load logging matrix file (TLLMF). The AMF will include the date; client name, site name, site address and current day's site associations. The current days site associations are the associations between portable control systems and loader (in the case loader based systems and, RFID tags and trucks. On a particular working day, all loaders on a site will be assigned PPD's; a loaders registration number will be assigned to its PPD by manual input and saved in the AMF. Before a truck is loaded for the first time for the day, it has an RFID tag associated with its registration number by manual input into the PPD, the PPD also saves this information in the AMF. The TLLMF logs the time, the PPD id, truck RFID, truck registration number and in the camera variant, an image of the body. From time to time, the PPD's on one site communicate with each other and the server, and merge and synchronise the information. The result will be identical copies of the AMF and TLLMF on each PPD and the server. The benefit of this is to have some redundancy of information in case the PPD's cannot access the server at required times.

The RFID tags are provided in a position that can be read by the RFID reader and in the case of a camera variant, the registration numbers are attached to the truck in a position that where an image of the number can be taken by the camera.

In the case of a loader based system, when it is a particular trucks turn to be loaded, it moves into a load position adjacent to the loader. The proximity of the truck's RFID tag and the portable control systems RFID reader facilitates the reading of the adjacent truck's tag. This reading of the tag is regarded as the load started. The PPD how logs load to the TLLMF. When the truck's RFID tag is not read for a predetermined time, the system regards this as load finished and the finish is logged to the TLLMF. In the camera variant, an image of the truck registration is acquired, the image may be used a back up of identification of the truck and to verify the trucks load status. This information is logged to the PPD.

In the case of the trailer based system, when it is a particular trucks turn to be loaded, it moves past the trailer. The proximity of the truck's RFID tag and the portable control systems RFID reader facilitates the reading only the adjacent truck's tag. This reading of the tag is regarded as the load started. The PPD now logs load to the TLLMF. After the truck is loaded it will return past the same trailer system or another trailer positioned on the exit route of the Job site. The RFID tag will be read and this will be regarded as the load finish time and this is logged to the TLLMF. In the camera variant, an image of the truck registration is acquired, the image can be used a back up of identification of the truck and to verify the trucks load status. This information is logged to the TLLMF.

A loader and trailer based systems may be used in conjunction with each other also.

At the end of the working day any loader operator or trailer based system operator'can use a site PPD to print a haulage receipt for a given truck rego/RFID tag and give it to the truck operator. This could include load numbers and time of loads.

At any time, authorised personal can access the server over the internet and print reports. Reports may include:
AMF and TLLMF for a site and date;
Truck activity between dates; and/or
Client activity.
Loader activity
Waiting times
Loads per truck
Trip times
Historical comparisons

In another aspect of invention, the present invention may be used to confirm the loading of a truck. The loader rotates between bucket loads. It has been found that the RFID signal will be reduced, or may be even lost, between rotations or there is provided a rotating RFID antenna that reads the RFID tag every time the reader faces the tag. It has been found that the loading process, in which the loader rotates during the filling of a truck, there will be a relatively repeatable pattern of RFID signal strength, where the RFID signal would be read and then lost, etc. In this aspect of invention, this pattern may be used to identify the confirmation of a truck being loaded.

It is also to be noted that although an RFID tag and reader have been disclosed, the present invention is equally applicable to a tag and reader of any frequency.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains, and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

It should be noted that where the terms “server”, “secure server” or similar terms are used herein, a communication device is described that may be used in a communication system, unless the context otherwise requires, and should not be construed to limit the present invention to any particular communication device type. Thus, a communication device may include, without limitation, a bridge, router, bridge-router (router), switch, node, or other communication device, which may or may not be secure.

It should also be noted that where a flowchart is used herein to demonstrate various aspects of the invention, it should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Various embodiments of the invention may be embodied in many different forms, including computer program logic for use with a processor (e.g., a microprocessor, microcontroller; digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an exemplary embodiment of the present invention, predominantly all of the communication between users and the server is implemented as a set of computer program instructions that is converted into a computer executable form, stored as such in a computer readable medium, and executed by a microprocessor under the control of an operating system.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Labview, Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g, a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program maybe distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

“Comprises/comprising” when used in this specification is taken to specify the presence of stated features, integers, steps or components but does not preclude the presence or addition of one or more other features, integers, steps, components or groups thereof.” Thus, unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

1. A method of tracking an object(s) in the workplace, the method comprising the steps of:
associating either a tag or reader with an object to be tracked,
providing a corresponding reader or tag in the workplace,
tracking the object via at least one proximity event of the tag and reader.

2. A method as claimed in claim 1, wherein the workplace is a construction site.

3. A method as claimed in claim 1, where a tag is associated with a truck.

4. A method as claimed in claim 1, wherein a reader is provided on a loader.

5. (canceled)

6. A method of determining whether a object is functioning within a workplace, the method comprising the steps of:
associating a tag or reader with the object
providing a corresponding reader or tag in the workplace,
monitoring the signal strength of the tag or reader
determining from the monitored signal whether a first signal strength and a second, lower, signal strength is monitored.

7. A method as claimed in claim 6, wherein the object is a loader.

8. A method as claimed in claim 6, wherein the signal strength is a continuous analogue signal that varies in amplitude.

9. A method as claimed in claim 6, wherein the signal strength over a period of time provides a “signature” of the signal, the signature of having a relative shape that identifies the action of the loader.

10. A method as claimed in claim 6, further comprising the step of determining if the monitored first and second signals are repeated over a period of time.

11. A method as claimed in claim 1, wherein the tag and/or reader are RFID tag(s) and/or reader(s).

12. A system adapted to track an object(s) in the workplace, comprising:
a tag or reader adapted to be associated with an object to be tracked,
a corresponding reader or tag adapted to be associated with the workplace,
tracking means adapted to determine at least one proximity event of the tag and the reader.

13. A system as claimed in claim 12, wherein the workplace is a construction site.

14-16. (canceled)

17. A system adapted to determine whether a object is functioning within a workplace, the system comprising:
a tag or reader adapted to be associated with an object to be tracked,
a corresponding reader or tag adapted to be associated with the workplace,
monitoring the signal strength of the tag or the reader
determining from the monitored signal whether a first signal strength and a second, lower, signal strength is monitored.

18. A system as claimed in claim 17, wherein the object is a loader.

19. A system as claimed in claim 17, wherein the signal strength is a continuous analogue signal that varies in amplitude.

20. A system as claimed in claim 17, wherein the signal strength over a period of time provides a “signature” of the signal, the signature of having a relative shape that identifies the action of the loader.

21. A system as claimed in claim 17, further comprising determining if the monitored first and second signals are repeated over a period of time.

22. A system as claimed in claim 17, wherein the tag and/or reader are RFID tag(s) and/or reader(s).

23. Apparatus adapted to determine whether a object is functioning within a workplace, said apparatus comprising:
processor means adapted to operate in accordance with a predetermined instruction set,
said apparatus, in conjunction with said instruction set, being adapted to perform the method as claimed in claim 1.

24. A computer program product comprising:
a computer usable medium having computer readable program code and computer readable system code embodied on said medium for cooperating with a data processing system, and, in association with other apparatus, device(s) and/or system(s), being adapted to determine whether a object is functioning within a workplace in accordance with the method as claimed in claim 1.

25-26. (canceled)
